(19) United States
(12) Patent Application Publication
(10) Pub. No.: US 2026/0281955 A1
(43) Pub. Date: Sep. 17, 2026

(54) SIDELINK COMMUNICATION METHOD AND COMMUNCIATION DEVICE

(71) Applicant: GUANGDONG OPPO MOBILE TELECOMMUNICATIONS CORP., LTD., Dongguan (CN)

(72) Inventors: Xinlei YU, Dongguan (CN); Yang LIU, Dongguan (CN)

(21) Appl. No.: 19/544,098

(22) Filed: Feb. 19, 2026

Related U.S. Application Data
(63) Continuation of application No. PCT/CN2023/114186, filed on Aug. 22, 2023.

(51) Int. Cl. H04W 64/00; H04W 8/22; H04W 92/18

(52) U.S. Cl. CPC H04W 64/00; H04W 8/22; H04W 92/18

(57) ABSTRACT

A method of sidelink positioning includes that: a first device sends a first sidelink positioning protocol (SLPP) message to a second device, where the first SLPP message is associated with a first non-access stratum (NAS) signaling, the first NAS signaling includes application layer identifiers of M terminal devices for sidelink positioning, and the application layer identifiers of the M terminal devices are arranged in the first NAS signaling according to a first order, M being a positive integer greater than or equal to 1. The first SLPP message includes information fields corresponding to the M terminal devices, the information fields corresponding to the M terminal devices are respectively used to carry positioning-related data corresponding to the M terminal devices, and an order of the information fields corresponding to the M terminal devices is determined based on the first order.

### CROSS-REFERENCE TO RELATED APPLICATION

This application is a continuation of International Patent Application No. PCT/CN2023/114186 filed on Aug. 22, 2023, the disclosure of which is hereby incorporated by reference in its entirety.

### BACKGROUND

In sidelink positioning scenarios, positioning-related data of multiple terminal devices may be exchanged between a location management function (LMF) and terminal devices through a sidelink positioning protocol (SLPP) message. At this time, how to distinguish the positioning-related data of the different terminal devices in the SLPP message is a problem that needs to be solved.

### SUMMARY

The present application relates to the technical field of communications, and in particular to a sidelink communication method and a communication device.

Embodiments of the present application provide a sidelink positioning method and a communication device. Various aspects of the embodiments of the present application will be described in detail below.

In a first aspect, there is provided a method of sidelink positioning, including that: a first device sends a first SLPP message to a second device. The first SLPP message is associated with first non-access stratum (NAS) signaling, the first NAS signaling includes application layer identifiers of M terminal devices for sidelink positioning, the application layer identifiers of the M terminal devices are arranged in the first NAS signaling according to a first order, and M is a positive integer greater than or equal to 1. The first SLPP message includes information fields corresponding to the M terminal devices, the information fields corresponding to the M terminal devices are respectively used to carry positioning related data corresponding to the M terminal devices, and an order of the information fields corresponding to the M terminal devices is determined based on the first order.

In a second aspect, there is provided a method of sidelink positioning, including that: a first device sends a first SLPP message to a second device. The first SLPP message is associated with first NAS signaling, the first NAS signaling includes application layer identifiers of M terminal devices for sidelink positioning, and the application layer identifiers of the M terminal devices are arranged in the first NAS signaling according to a first order, M being a positive integer greater than or equal to 1. The first SLPP message includes indexes of K terminal devices among the M terminal devices, and the indexes of the K terminal devices are determined based on the first order, where K is a positive integer greater than or equal to 1, and K is less than or equal to M.

In a third aspect, there is provided a communication device, including a transceiver, a memory, and a processor. The memory is used for storing a program, and the processor is configured to invoke the program in the memory and control the transceiver to receive or send signals, to cause the communication device to perform the method as described in the first aspect.

In the embodiments of the present application, positioning-related data of terminal devices in a SLPP message is organized based on the order of application layer identifiers of the terminal devices in NAS signaling, so that the positioning-related data of different terminal devices can be implicitly distinguished.

### BRIEF DESCRIPTION OF THE DRAWINGS

FIG. 1 is an exemplary diagram of a system architecture of a wireless communication system applicable to embodiments of the present application.

FIG. 2 is a schematic diagram of a sidelink positioning procedure.

FIG. 3 is a schematic diagram of another sidelink positioning procedure.

FIG. 4 is a schematic flowchart of a sidelink positioning method provided by a first embodiment of the present application.

FIG. 5 is a schematic flowchart of a sidelink positioning method provided by a second embodiment of the present application.

FIG. 6 is a schematic structural diagram of a communication device provided by an embodiment of the present application.

FIG. 7 is a schematic structural diagram of a communication device provided by another embodiment of the present application.

FIG. 8 is a schematic structural diagram of a communication device provided by another embodiment of the present application.

FIG. 9 is a schematic structural diagram of a communication device provided by another embodiment of the present application.

FIG. 10 is a schematic structure diagram of an apparatus provided by embodiments of the present application.

### DETAILED DESCRIPTION

Hereinafter, technical solutions in the present application will be described with reference to the accompanying drawings.

### Communication System Architecture

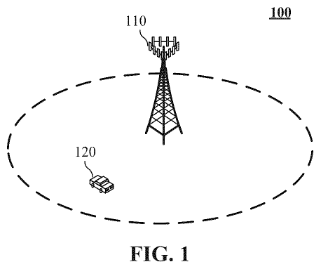

FIG. 1 is an exemplary diagram of a system architecture of a wireless communication system 100 applicable to embodiments of the present application. The wireless communication system 100 may include a network device 110 and a terminal device 120. The network device 110 may be a device in communication with the terminal device 120. The network device 110 may provide communication coverage for a particular geographic area and may communicate with the terminal device 120 located within the coverage area.

FIG. 1 exemplarily illustrates a network device and a terminal device. The wireless communication system 100 may include one or more network devices 110 and/or one or more terminal devices 120. For one network device 110, the one or more terminal devices 120 may all be located in coverage of the network device 110, or may all be located outside coverage of the network device 110, or may be with a part being located in coverage of the network device 110 and the other part may be located outside the coverage of the network device 110, which is not limited in the embodiments of the present application.

Optionally, the wireless communication system 100 may further include other network entities, such as a network controller and a mobility management entity, and the embodiments of the present application are not limited thereto.

It should be understood that the technical solutions of the embodiments of the present application may be applied to various communication systems, such as a fifth generation (5G) system or a new radio (NR) system, a long term evolution (LTE) system, an LTE frequency division duplex (FDD) system, an LTE time division duplex (TDD), and the like. The technical solution provided in the present application may also be applied to future communication systems, such as a sixth generation mobile communication system, a satellite communication system, and the like.

The terminal device in the embodiments of the present application may be referred to as user equipment (UE), an access terminal, a subscriber unit, a subscriber station, a mobile station, a mobile station (MS), a mobile Terminal (MT), a remote station, a remote terminal, a mobile device, a user terminal, a terminal, a wireless communication device, a user agent, or a user device, and the like. In the embodiments of the present application, the terminal device may be a device that provides voice and/or data connectivity to a user and may be used to connect people, objects, and machines, for example, a handheld device having a wireless connection function, a vehicle-mounted device, or the like. The terminal device in the embodiments of the present application may be a mobile phone, a Pad, a notebook computer, a handheld computer, a mobile internet device (MID), a wearable device, a virtual reality (VR) device, an augmented reality (AR) device, a wireless terminal in industrial control, a wireless terminal in self driving, a wireless terminal in remote medical surgery, a wireless terminal in smart grid, a wireless terminal in transportation safety, a wireless terminal in smart city, a wireless terminal in smart home, or the like. Optionally, UE may be used to act as a base station. For example, the UE may act as a scheduling entity that provides sidelink signals between the terminal devices in V2X or D2D, etc. For example, cellular telephones and automobiles communicate with each other using sidelink signals. Communication between cellular phones and smart home devices does not need relaying communication signals through base stations.

The network device in the embodiments of the present application may be a device that communicates with terminal devices, and the network device may also be referred to as an access network device or a radio access network device. For example, the network device may be a base station. The network device in the embodiments of the present application may refer to a radio access network (RAN) node (or device) that connects the terminal devices to the wireless network.

The base station may broadly encompass or be interchanged with the following various designations, such as a NodeB, an evolved NodeB (eNB), a next generation NodeB (gNB), a relay station, an access point, a transmitting and receiving point (TRP), a transmitting point (TP), a master station (MeNB), a secondary station (SeNB), a multi-standard radio (MSR) node, a home base station, a network controller, an access point (AP), a transmission node, a transceiver node, a base band unit (BBU), a remote radio unit (RRU), an active antenna unit (AAU), a remote radio head (RRH), a central unit (CU), a distributed unit (DU), a location node, and the like. The base station may be a macro base station, a micro base station, a relay node, a donor node, or the like, or a combination thereof. The base station may also refer to a communication module, a modem, or a chip for disposal within the aforementioned devices or apparatuses. The base station may also be a mobile switching center, as well as a device that undergoes base station functions in D2D communication, vehicle-to-everything (V2X) communication, machine-to-Machine (M2M) communication, a network-side device in 6G network, and a device that undergoes base station functions in a future communication system, or the like. The base station may support networks of the same or different access technologies. The embodiments of the present application do not limit the specific technology and the specific device form adopted by the network device.

The base station may also be fixed or mobile. For example, a helicopter or drone may be configured to act as a mobile base station, and one or more cells may move according to the location of the mobile base station. In other examples, a helicopter or drone may be configured as a device communicating with another base station.

In some deployments, the network device in the embodiments of the present application may refer to a CU or a DU, or the network device includes a CU and a DU. The gNB may also include an AAU.

The network device and terminal device may be deployed on land, including indoor or outdoor, handheld, wearable, or vehicle-mounted, or may also be deployed on the water, or deployed on aircraft, balloons and satellites in the air. In the embodiments of the present application, the scenario in which the network device and the terminal device are located is not limited.

It should be understood that all or part of the functions of the communication device in the present application may also be implemented by software functions running on hardware, or by virtualized functions instantiated on a platform (e.g., a cloud platform).

### Sidelink (SL) Positioning

SL positioning refers to positioning among terminal devices. Some of the concepts involved in SL positioning are explained below.

In SL positioning, a target terminal device refers to a terminal device to be positioned. The distance, direction, and/or position of the target terminal device may be measured with the support from one or more SL reference terminal devices by using SL positioning or ranging. In some embodiments, the target terminal device may also be referred to as a target UE.

In SL positioning, a located terminal device refers to a SL reference terminal device of which the location is known or is able to be known using air interface (Uu) based positioning. A located terminal device can be used to determine the location of a target terminal device. In some embodiments, the located terminal device may also be referred to as a located UE.

In SL positioning, the SL terminal device refers to another terminal device supporting positioning of the target terminal device. For example, a SL reference terminal device may provide positioning-related information by transmitting or receiving reference signals for positioning on a sidelink, thereby supporting positioning of the target terminal device. The SL reference terminal device may also be referred to as a SL reference UE. In some cases, the SL reference terminal device may also be referred to as an anchor terminal device, or an anchor UE.

In SL positioning, a SL client terminal device refers to a third-party terminal device other than the target terminal device and the reference terminal device. The SL positioning client terminal device may initiate a ranging/sidelink positioning service request on behalf of the application residing on it. The SL positioning client terminal device may also be referred to as a SL positioning client UE. It should be noted that the SL positioning client terminal device does not have to support ranging/positioning capability, but a communication between the SL positioning client terminal device and the SL reference terminal device/target terminal device has to be established, either via PC5 or via cellular network, for the transmission of positioning request and positioning result.

SL positioning scenarios include two scenarios, i.e., in-coverage (IC) scenario and out-of-coverage (OOC) scenario. In the IC scenario, since an anchor terminal device and/or a target terminal device are in the coverage of the communication system, LMF can be involved in and control a SL positioning procedure. In the positioning procedure, SL positioning assistance information for the target terminal device and the anchor terminal device may be uploaded to the LMF, collected by the LMF in a unified manner, and then the LMF calculates results, thereby realizing the positioning of the target terminal device.

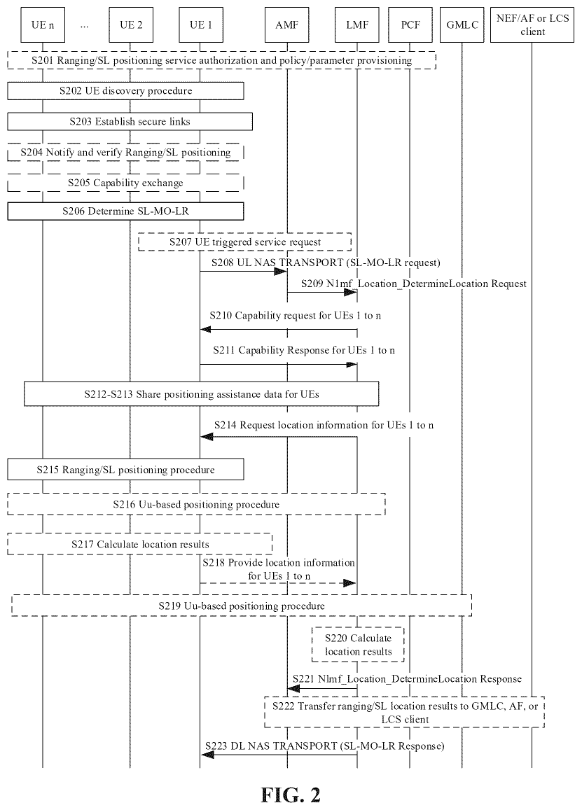

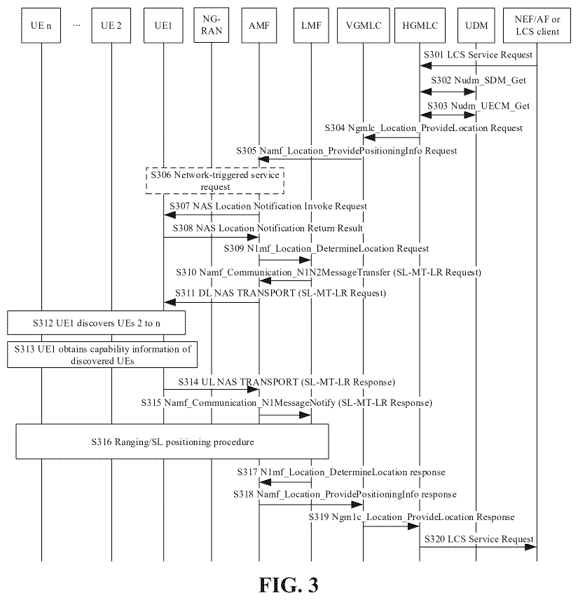

In the IC scenario, there are many types of ranging/sidelink positioning procedures involving LMF. For example, there is a ranging/sidelink positioning procedure, in which a terminal device sends a sidelink (SL) positioning request to an access and mobility management function (AMF) through NAS signaling. The SL positioning request in the positioning procedure may be referred to as a sidelink mobile originated location request (SL-MO-LR). As another example, there is a ranging/sidelink positioning procedure, in which a terminal device receives, through NAS signaling, a SL positioning request sent by AMF. The SL positioning request in the positioning procedure may be referred to as a sidelink mobile terminated location request (SL-MT-LR). Reference tos details are made to the introduction of FIG. 2 and FIG. 3 hereinafter.

### Procedures of SL-MO-LR Involving LMF

FIG. 2 is a schematic diagram of a procedure of SL-MO-LR involving LMF. The precondition of this procedure is that UE1 is in coverage and registered with a serving public land mobile network (PLMN). UEs 2 to n may not be in n coverage or may be outside coverage. If in coverage, UEs 2 to n may be registered with the same serving PLMN as UE1, or may be registered with a different serving PLMN from the UE1. Various steps involved in FIG. 2 will be described in detail below.

In S201, Ranging/SL positioning service authentication and policy/parameter provisioning are provisioned.

In S202, UE discovery is performed. For example, based on a trigger of service request (e.g. received from the application layer), UE discovery is performed for Ranging/SL positioning. If UE1 is the target UE, UE1 discovers UEs 2 to n. If UE1 is the located UE, the target LE (i.e. one of the UEs 2 to n) discovers UE1 and other UEs in the set of UEs 2 to n.

In S203, secure links are established between UEs 1 to n. Secure groupcast and/or unicast links are established between UEs 1 to n, to enable UE1 to exchange ranging and sidelink positioning protocol (RSPP) messages over PC5-U reference point with each of UEs 2 to n, and possibly to enable UEs 2 to n to exchange RSPP over PC5-U between each other. RSPP and SLPP mentioned herein may be understood as the same protocol. Or, the RSPP message and the SLPP message may be understood as the same type of message.

In S204, Ranging/SL positioning is notified and verified. UE1 and UEs 2 to n may communicate over PC5 for authorization of Ranging/SL positioning and receiving quality of service (QoS) parameters (if needed). Each of UEs verifies whether Ranging/SL positioning is permitted and whether Ranging/SL positioning results may be transferred to a location service (LCS) Client or application function (AF), according to any service authorization and policy/parameter provisioning received at step S201. QoS requirements for the Ranging/SL positioning may be also provided based on QoS requirements in the service request.

In S205, Capability Exchange. UE1 may obtain the Sidelink positioning capabilities of UEs 2 to n using the groupcast and/or unicast links established in step 203.

In S206, Determine SL-MO-LR. Based on the Sidelink positioning capabilities of UE1/ . . . /UEn, the target UE determines that SL-MO-LR is to be performed. If UE1 is the Located UE (i.e. when the target UE is one of UEs 2 to n and does not have NAS connection), the target UE initiates an SL-MO-LR service request to UE1.

In S207, UE triggers a service request. If UE1 is in connection management idle (CM idle) state, UE1 instigates a LE triggered Service Request in order to establish a signalling connection with a serving AMF of UE1.

In S208, an UL NAS TRANSPORT message is transmitted. UE1 sends a supplementary services SL-MO-LR request to the serving AMF in an UL NAS TRANSPORT message. The SL-MO-LR request indicates the other UEs 2 to n using application layer identifier (ID). The SL-MO-LR request may also indicate any assistance data needed, indicates whether location calculation assistance is needed, and indicates whether location results should be transferred to an LCS client or AF. The message shall include the identity of the LCS client or the AF and may include the address of the gateway mobile location center (GMLC) through which the LCS client or AF (via network exposure function (NEF)) should be accessed.

In S209, Nlmf_Location_DetermineLocation request is transmitted. The serving AMF selects an LMF serving UE1 (e.g. an LMF that supports Sidelink positioning/ranging) and sends an Nlmf_Location_DetermineLocation request towards the LMF with information from the SL-MO-LR Request.

In S210, the LMF sends a request to UE1 for the capabilities of UEs 1 to n.

In S210, UE 1 returns its capabilities to the LMF. UE1 may additionally return the capabilities of the UEs, other than UE1, obtained at step S205 if requested at step S210.

In S212, UE1 may send a request for specific assistance data to the LMF.

In S213, LMF sends the requested assistance data to UE1. UE1 forwards the assistance data received from LMF to UEs 2 to n. The assistance data may assist UEs 1 to n to obtain Sidelink location measurements at step S215 and/or may assist UE1 to perform subsequent calculation of Sidelink positioning/ranging location results.

In S214, if the SL-MO-LR request at step S208 indicates that location calculation assistance is needed and/or indicates transfer of Sidelink positioning/ranging location results to an LCS Client or AF, the LMF sends a request for location information to UE1. The LMF may send a request for location information to UEs 2 to n if they are served by the LMF.

In S215, UE1 instigates a Sidelink positioning/ranging procedure among UEs 1 to n, in which UEs 1 to n obtain Sidelink location measurements, and UEs 2 to n transfer their Sidelink location measurements to UE1 and/or to the LMF.

In S216, if target UE's absolute location is required to be measured and if absolute location of located UE(s) is not available, then the target UE sends a request to the located UE(s) to trigger Uu based procedure to let the located UE(s) acquire their own absolute location.

In S217, if LMF determines to use UE based calculation, at least one of UE1 to UEn calculates Sidelink positioning/ranging location results based on the Sidelink location measurements obtained at step S215. The Sidelink positioning/ranging location results can include absolute locations, relative locations, or ranges and/or directions related to the UEs 1 to n.

In S218, if UE1 received a request for location information at step S214, UE1 sends a response to the LMF and includes in the response the Sidelink location measurements obtained at step S215, the Sidelink positioning/ranging location results obtained at step S217 (if step S217 was performed), or located UE's absolute location obtained at step S216.

In S219, if target UE's absolute location is required to be measured at step S208 and if absolute location of located UE(s) is not received at step S218, LMF can either retrieved the location of the located UE(s) locally or triggers Uu based procedure to the GMLC to acquire the absolute location of the located UE(s) using Application Layer ID or generic public subscription identifier (GPSI) of the located UE(s).

In S220, the LMF calculates Sidelink positioning/ranging location results for UEs 1 to n from the Sidelink location measurements received at step S218 and absolute location of Located UE(s) at step S219. The Sidelink positioning/ranging location results can include absolute locations, relative locations, ranges and/or directions related to the UEs 1 to n.

In S221, the LMF returns an Nlmf_Location_DetermineLocation response to the AMF. The response includes the ranging/Sidelink positioning location results.

In S222, the AMF sends the ranging/Sidelink positioning location results to the GMLC, and to an AF or LCS client. The Sidelink positioning/ranging location results include the identities for the respective UEs 1 to n received at step S218.

In step S223, the LMF returns a supplementary services SL-MO-LR response message to UE1 in a DL NAS TRANSPORT message. The response message includes any ranging/Sidelink positioning location results calculated at step S220. If UE1 is located UE, and the target UE is one of the UEs 2 to n that does not have NAS connection, then UE1 may transfer the ranging/Sidelink positioning location results to the target UE.

### Procedures of SL-MT-LR Involving LMF

The SL-MT-LR procedure may be used to estimate the relative locations or distances and/or directions between the terminal devices. This procedure is described below with reference to FIG. 3. FIG. 3 illustrates a procedure to enable an LCS Client or AF to obtain Ranging/Sidelink Positioning location results for a group of terminal devices (i.e. UE1, UE2, . . . , UE n in FIG. 3). In the procedure, the GMLC determines one of the n UEs as UE1 (i.e. target UE) and one or more other UEs as UEs 2 to n (i.e. reference/located UEs). The Ranging/Sidelink Positioning location results may include absolute locations, relative locations, ranges or directions related to the UEs, based on the service request. The precondition of the procedure in FIG. 3 is that at least one of the n UEs is in coverage and registered with a serving PLMN.

In step S301, the LCS Client or the AF (via NEF) sends an LCS service request to the (H)GMLC for Ranging/Sidelink Positioning location results for the n UEs. The n UEs may each be identified by a GPSI or a subscription permanent identifier (SUPI). The service request may include the required QoS, the required location results (e.g. absolute locations, relative locations or distances and/or directions related to the UEs), the SL reference UE(s) in case of determining the relative locations, distance, or direction. In addition, an application layer ID shall be included for each of the n UEs to enable discovery of the n UEs at step S312.

In S302, the (H)GMLC invokes a Nudm_SDM_Get service operation towards unified data management (UDM) of each of the n UEs to get a privacy setting of the UE identified by its GPSI or SUPI. The UDM returns the Privacy setting of the UE.

In S303, the (H)GMLC invokes a Nudm_UECM_Get service operation towards the UDM of each of the n UEs, using the GPSI or SUPI of each UE. The (H)GMLC selects the UE (e.g. which is UE1 hereinafter) that initiates the Ranging/SL Positioning and selects the corresponding serving AMF.

In S304, for a non-roaming case, this step is skipped. In the case of roaming, the (H)GMLC may receive an address of a (V)GMLC from the UDM in step S303; otherwise, the (H)GMLC may use a network repository function (NRF) service in the (H)PLMN to select an available (V)GMLC in the (V)PLMN, based on the (V)PLMN identification contained in the AMF address received in step S3033. The (H)GMLC then sends the location request to the (V)GMLC by invoking a Ngmlc_Location_ProvideLocation request (or service operation) towards the (V)GMLC. In the case when the (H)GMLC did not receive the address of the (V)GMLC, or when the (V)GMLC address is the same as the (H)GMLC address, or when both PLMN operators agree, the (H)GMLC sends a location service request message to the serving AMF.

In step S305, in the case of roaming, the (V)GMLC first authorizes that the location request is allowed. If the location request is not allowed, an error response is returned. The (H)GMLC or (V)GMLC invokes the Namf_Location_ProvidePositioningInfo request (or service operation) towards the AMF serving UE1, to request Sidelink positioning/ranging location results of the n UEs. The service operation includes the SUPI of UE1, Application layer IDs of the n UEs, and the client type. The service operation may further include the required LCS QoS, the required location results (e.g. relative locations or ranges and directions related to the UEs) and other attributes as received or determined in step S301.

In S306, If UE1 is in CM idle state, the AMF initiates a Service Request procedure to establish a signalling connection with UE1.

In steps S307 to S308, if the indicator of privacy check indicates an action is needed, then same operation as that of steps S307 to S308 is carried out, that is, NAS location notification invoke request and NAS location notification return result are carried out.

In S309, the serving AMF selects an LMF serving UE1 (e.g. an LMF that supports Ranging/Sidelink Positioning) and sends an Nlmf_Location_DetermineLocation request (or service operation) towards the LMF. The request may carry the information received at step S305, e.g. required location results (e.g. relative locations or ranges and directions between UEs), SL reference UE(s) in case of relative locations, Application layer IDs of the UEs.

In step S310, the LMF sends an SL-MT-LR request to the serving AMF as a supplementary services message, using the Namf_Communication_N1N2MessageTransfer request (or service operation). The SL-MT-LR request may include the application layer IDs of UEs 2 to n, the types of required location results (e.g. relative locations or distances and/or directions), and the required SL reference UE(s) in case of relative locations.

In S311, the serving AMF forwards the SL-MT-LR request to UE1 using a DL NAS TRANSPORT message.

In S312, UE1 attempts to discover the other UEs 2 to n using their Application Layer IDs.

In S313, UE1 obtains the sidelink positioning capabilities of the discovered UEs via the SLPP.

In S314, UE1 returns a supplementary services SL-MT-LR response to the serving AMF in an UL NAS TRANSPORT message. The SL-MT-LR response indicates which of UEs 2 to n have been discovered and the sidelink positioning capabilities of the discovered UEs.

In S315, the serving AMF forwards the SL-MT-LR response to the LMF.

In S316, a Sidelink positioning/ranging procedure is carried out among UEs 1 to n. This procedure can be as described for steps S210 to S219 in FIG. 2, with the difference that Ranging/Sidelink Positioning location measurement data or results are always returned to the LMF. The LMF indicates to UE1 that the Ranging/Sidelink Positioning location results will be calculated by the LMF.

In S317 to S320, the LMF returns the Sidelink positioning/ranging location results to the LCS Client or AF.

According to the above description, in the procedures of SL positioning involving LMF, positioning-related data of multiple terminal devices may be exchanged between the LMF and the terminal device through an SLPP message. Taking the procedure shown in FIG. 2 as an example, capability information of the UEs 1 to n (see steps S210 to S211), positioning assistance information (see steps S212 to S213), and location information (see steps S214 and S218) may be exchanged between the LMF and the UEL. At this time, how to distinguish the positioning-related data for different terminal devices in the SLPP message is a problem that needs to be solved.

According to the description of FIG. 2 or FIG. 3, in the procedures of sidelink positioning involving LMF, NAS signaling is exchanged between the terminal device and the AMF, and application layer identifiers (IDs) of other terminal devices used for sidelink positioning are carried in the NAS signaling.

For example, referring to steps S208 to S209 of FIG. 2, the UE1 sends an SL-MO-LR request to the LMF via the AMF through an NAS message (UL NAS TRANSPORT message), and indicates the application layer IDs of the UEs 2 to n in the SL-MO-LR request.

As another example, referring to steps S310 to S311 in FIG. 3, the LMF sends an SL-MT-LR request to the UE 1 via the AMF through an NAS message (DL NAS TRANSPORT message), and indicates the application layer IDs of the UEs 2 to n in the SL-MT-LR request.

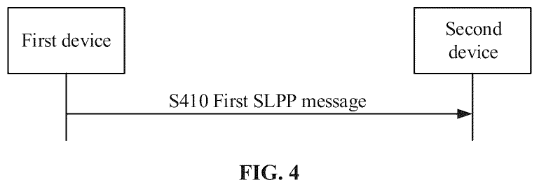

For another example, referring to steps S314 to S314 in FIG. 4, UE1 sends a response message for the SL-MT-LR request to the UE1 via the AMF through an NAS message (UL NAS TRANSPORT message). The response message for the SL-MT-LR request may indicates which of UEs have been discovered based on the application layer IDs of the UEs.

As can be seen, in the procedures of sidelink positioning involving LMF, application layer IDs of other terminal devices used for sidelink positioning are exchanged between the terminal device and the LMF. Therefore, in view of the above-mentioned problem of how to distinguish positioning-related data of different terminal devices in the SLPP message, one possible solution is that the application layer IDs in the NAS signaling is still included in the SLPP message, and the application layer IDs are used to distinguish the positioning-related data of different terminal devices. In general, however, it is not a conventional way that the application layer IDs is explicitly indicated in the SLPP message, and this is because the application layer IDs cannot be directly identified by the LMF. In order to enable understanding of the application layer IDs, the LMF relies on GMLC to parse the application layer IDs. This parsing process is not performed in SLPP layer and would thus introduce excessive inter-layer interactions. In addition, since the application layer IDs are relatively long, the direct use of the application layer IDs will lead to more signaling overhead. Therefore, it is not suggested that the application layer IDs are directly included in the SLPP message in the embodiments of the present application. However, since a common list for the application layer IDs of other terminal devices for sidelink positioning has been formed between the terminal device and the LMF through NAS signaling exchange, the embodiments of the present application hopes to solve the above problem by utilizing the order of the application layer IDs provided by the application layer ID list. The present application will be described in detail below.

### First Embodiment

FIG. 4 is a schematic flowchart of a sidelink positioning method provided by a first embodiment of the present application. The method of FIG. 4 may be applied to an in-coverage sidelink positioning procedure. Or, the method of FIG. 4 may be applied to a procedure of sidelink positioning involving LMF. The sidelink positioning procedure may be one that is initiated by a terminal device, such as the SL-MO-LR procedure mentioned above. Alternatively, the sidelink positioning procedure may be one that is received by a terminal device, such as the SL-MT-LR procedure mentioned above.

The method of FIG. 4 is described from the perspective of interactions between the first device and the second device. In some implementations, the first device is a terminal device, and the second device is LMF. In some implementations, the first device is LMF, and the second device is a terminal device.

With reference to FIG. 4, in S410, a first device sends a first SLPP message to a second device.

In some implementations, the first SLPP message may be used to provide positioning-related data of a terminal device.

In some implementations, the first SLPP message may be used to provide capability information of a terminal device. For example, the first SLPP message is an SLPP ProvideCapabilities message. In this case, the first device is a terminal device, and the second device is LMF.

In some implementations, the first SLPP message may be used to provide location information of a terminal device. For example, the first SLPP message is an SLPP ProvideCapabilities message. In this case, the first device is a terminal device, and the second device is LMF.

In some implementations, the first SLPP message may be used to provide positioning assistance data for a terminal device. For example, the first SLPP message is an SLPP ProvideAssistanceData message. In this case, the first device is LMF, and the second device is a terminal device.

In some implementations, the first SLPP message is associated with a first NAS signaling. For example, the first SLPP message and the first NAS signaling are for the same sidelink positioning procedure, or the first SLPP message is triggered (which may be indirectly triggered) by the first NAS signaling.

In some implementations, the first NAS signaling may be used to carry a sidelink positioning request message initiated by a terminal device. The sidelink positioning request message initiated by the terminal device may be an SL-MO-LR request message.

In some implementations, the first NAS signaling may be used to carry a sidelink positioning request message received by a terminal device. The sidelink positioning request message received by the terminal device may be an SL-MT-LR request message.

In some implementations, the first NAS signaling may be used to carry a response message for a sidelink positioning request message received by a terminal device. The response message for the sidelink positioning request message received by a terminal device may be a response message for an SL-MT-LR request message.

In some implementations, the first NAS signaling includes application layer identifiers of M terminal devices for sidelink positioning, and M is a positive integer greater than or equal to 1. The application layer identifiers of the M terminal devices are arranged in the first NAS signaling according to a first order. As an example, assuming that the first NAS signaling includes sequentially an application layer ID of UE a, application layer ID of UE b, and application layer ID of UE c, then the first order is: UE a→UE b→UE c.

In some implementations, the application layer identifiers of the M terminal devices may form an application program ID list, and the application program ID list may record the application layer identifiers of the M terminal devices according to the first order.

As mentioned above, the first NAS signaling may be used to carry an SL-MT-LR request message or a response message for the SL-MT-LR request message. Application layer IDs in the SL-MT-LR request message and the response message for the SL-MT-LR request message may be the same or different. If the application layer IDs in the SL-MT-LR request message and the response message for the SL-MT-LR request message are different, the first NAS signaling may be NAS signaling carrying the SL-MT-LR request message or NAS signaling carrying the response message for the SL-MT-LR request message. Alternatively, whether the first NAS signaling is NAS signaling carrying the SL-MT-LR request message or NAS signaling carrying the response message for the SL-MT-LR request message may be determined based on pre-configuration information, or configuration information from the network device.

In some implementations, the first SLPP message includes information fields corresponding to M terminal devices. The M terminal devices refer to the M terminal devices indicated by the application layer identifiers in the first NAS signaling. The information fields corresponding to the M terminal devices are respectively used for carrying positioning-related data corresponding to each of the M terminal devices. The positioning-related data may include, for example, one or more of the following: capability information of the terminal device, position information of the terminal device, or positioning assistance data for the terminal device.

In some implementations, in the first SLPP message, the information fields corresponding to the M terminal devices may form a list.

In some implementations, in the first SLPP message, an order of the information fields corresponding to the M terminal devices is determined according to the first order. For example, the order of the information fields corresponding to the M terminal devices matches or corresponds to the first order. The order of the information fields corresponding to the M terminal devices matching or corresponding to the first order may mean that: an i-th information field among the information fields corresponding to the M terminal devices is used for carrying positioning-related data of the terminal device corresponding to an i-th application layer identifier in the first NAS signaling. As an example, assuming that the first NAS signaling includes sequentially an application layer ID of UE a, application layer ID of UE b, and application layer ID of UE c, then the first order is: UE a→UE b→UE c. Correspondingly, the first SLPP message may include three information fields, namely, an information field corresponding to the UE a, an information field corresponding to the UE b, and an information field corresponding to the UE c. Among the three information fields, the information field corresponding to the UE a is placed first, the information field corresponding to the UE b is placed second, and the information field corresponding to the UE c is placed third.

Hereinafter, the implementation of the first SLPP message will be described in more detail by taking the first SLPP message as an SLPP ProvideCapabilities message, an SLPP ProvideLocationInformation message, or an SLPP ProvideAssistanceData message as examples, respectively.

### First Example: The First Message is SLPP ProvideCapabilities Message

In the first example, the first device is a terminal device (hereinafter referred to as UE1), the second device is an LMF, and the M terminal devices mentioned above are referred to as UEs 2 to n in the first example.

In first NAS signaling (which may be used to carry an SL-MO-LR request message, an SL-MT-LR request message, or an SL-MT-LR response message), the application layer IDs of the UEs 2 to n form an application layer ID list. In the SLPP ProvideCapabilities message, capability information of the UEs 2 to n are arranged by the UE1 according to the order of the application layer ID list, thereby forming ProvideCapabilitiesList. In addition, the capability information of the UE1 may be placed first in the ProvideCapabilitiesList, followed in sequence by the capability information of the UEs 2 to n.

An example that the SLPP ProvideCapabilities message carrying ProvideCapabilitiesList is given below.
ProvideCapabilities::=SEQUENCE {
   criticalExtensions CHOICE {
      c1 CHOICE {
         provideCapabilities ProvideCapabilities-IEs,
         provideCapabilitiesList ProvideCapabilitiesList,
         spare2 NULL, spare1 NULL
      },
      criticalExtensionsFuture SEQUENCE { }
   }
}
ProvideCapabilitiesList:: =SEQUENCE (SIZE(1 . . . maxUEs)) OF ProvideCapabilities-IEs
ProvideCapabilities-IEs::=SEQUENCE {
   commonIEsProvideCapabilities CommonIEsProvideCapabilitie OPTIONAL,
      SL-Multi-RTT-ProvideCapabilities SL-Multi-RTT-ProvideCapabilities OPTIONAL,
   SL-AoD-ProvideCapabilities SL-AoD-ProvideCapabilities OPTIONAL,
   SL-TDOA-ProvideCapabilities SL-TDOA-ProvideCapabilities OPTIONAL,
      nonCriticalExtensions SEQUENCE { }OPTIONAL
}

In the above example, the number of elements contained in the ProvideCapabilitiesList is denoted by maxUEs, and maxUEs=n.

### Second Example: The First Message is SLPP ProvideLocationInformation Message

In the second example, the first device is a terminal device (hereinafter referred to as UE1), the second device is an LMF, and the M terminal devices mentioned above are referred to as UEs 2 to n in the second example.

In the first NAS signaling (which may be used to carry an SL-MO-LR request message, an SL-MT-LR request message, or an SL-MT-LR response message), the application layer IDs of the UEs 2 to n form an application layer ID list. In SLPP ProvideLocationInformation message, location information of the UEs 2 to n are arranged by the UE1 according to the order of the application layer ID list, thereby forming ProvideLocationInformationList. Further, the location information of the UE1 may be placed first in the ProvideLocationInformationList, followed in sequence by the location information of the UEs 2 to n.

An example that the SLPP ProvideLocationInformation message carries ProvideLocationInformationList is given below.
ProvideLocationInformation::=SEQUENCE {
   criticalExtensions CHOICE {
      c1 CHOICE {
      provideLocationInformation ProvideLocationInformation-IEs,
      provideLocationInformationList ProvideLocationInformationList,
         spare2 NULL, spare1 NULL
      },
      criticalExtensionsFuture SEQUENCE { }
   }
}
ProvideLocationInformationList::=SEQUENCE (SIZE(1 . . . maxUEs)) OF ProvideLocationInformation-IEs
ProvideLocationInformation-IEs::=SEQUENCE {
commonIEsProvideLocationlnformation CommonIEsProvideLocationInformation OPTIONAL,
SL-Multi-RTT-ProvideLocationInformation SL-Multi-RTT-ProvideLocationInformation OPTIONAL,
SL-AoD-ProvideLocationInformation SL-AoD-ProvideLocationInformation OPTIONAL,
SL-TDOA-ProvideLocationInformation SL-TDOA-ProvideLocationInformation OPTIONAL,
nonCriticalExtensions SEQUENCE { }OPTIONAL,
}

In the above example, the number of elements contained in the ProvideLocationInformationList is denoted by maxUEs, and maxUEs=n.

### Third Example: The First Message is SLPP ProvideAssistanceData Message

In the third example, the first device is LMF, the second device is a terminal device (hereinafter referred to as UE1), and the M terminal devices mentioned above are referred to as UEs 2 to n in the third example.

In the first NAS signaling (which may be used to carry an SL-MO-LR request message, an SL-MT-LR request message, or an SL-MT-LR response message), the application layer IDs of the UEs 2 to n form an application layer identifier list. In SLPP ProvideAssistanceData message, positioning assistance data of the UEs 2 to n are arranged by the LMF according to the order of the application layer ID list, thereby forming ProvideAssistanceDataList. Further, the positioning assistance data of the UE1 may be placed first in the ProvideAssistanceDataList, followed in sequence by the positioning assistance data of the UEs 2 to n.
ProvideAssistanceData::=SEQUENCE {
   criticalExtensions CHOICE {
      c1 CHOICE {
         provideAssistanceData ProvideAssistanceData-IEs,
         provideAssistanceDataList ProvideAssistanceDataList,
         spare2 NULL, spare1 NULL
      },
      criticalExtensionsFuture SEQUENCE { }
   }
}
ProvideAssistanceDataList::=SEQUENCE (SIZE(1 . . . maxUEs)) OF
ProvideAssistanceData-IEs
ProvideAssistanceData-IEs::=SEQUENCE {
Editor's note: FFS on the detail
commonIEsProvideAssistanceData CommonIEsProvideAssistanceData OPTIONAL, SL-Multi-RTT-ProvideAssistanceData SL-Multi-RTT-ProvideAssistanceData OPTIONAL,
SL-AoD-ProvideAssistanceData SL-AoD-ProvideAssistanceData OPTIONAL,
SL-TDOA-ProvideAssistanceData SL-TDOA-ProvideAssistanceDataOPTIONAL,
nonCriticalExtensions SEQUENCE { }OPTIONAL,
}

In the above example, the number of elements contained in the ProvideAssistanceDataList is denoted by maxUEs, and maxUEs=n.

In some implementations, the order of the information fields corresponding to the M terminal devices being determined according to the first order may include that: the information fields corresponding to the M terminal devices are ordered according to a second order. The second order is determined based on the first order. The second order may be, for example, a reverse order of the first order. As an example, assuming that the first NAS signaling includes sequentially an application layer ID of UE a, application layer ID of UE b, and application layer ID of UE c, then the first order is: UE a→UE b→UE c. Correspondingly, the first SLPP message includes three information fields, namely, an information field corresponding to the UE a, an information field corresponding to the UE b, and an information field corresponding to the UE c. Among the three information fields, the information field corresponding to the UE c is placed first, the information field corresponding to the UE b is placed second, and the information field corresponding to the UE a is placed third.

In the first embodiment, positioning-related data of terminal devices in the SLPP message are organized based on the order of the application layer identifiers of the terminal devices in the NAS signaling, so that the positioning-related data of different terminal devices can be implicitly distinguished. That is, in the first embodiment, implicit indication of the M terminal devices is realized using the order information of the application layer identifiers in the NAS signaling, so that the positioning-related data of different terminal devices can be distinguished even if the application layer identifiers of the terminal devices are not included in the SLPP message. In this way, it can avoid introduction of complex inter-layer interactions by the LMF in order to parse application layer identifiers (where the parsing of application layer identifiers requires interactions with GMLC, which will introduce many unnecessary interaction procedures in non-SLPP layer), and can save signaling overhead (since the application layer identifiers are long, large signaling overhead will be introduced for including the application layer identifiers in the SLPP message).

As mentioned above, the first SLPP message includes the information fields corresponding to the M terminal devices. If positioning-related data of the i-th terminal device among the M terminal devices (where i is a positive integer, and 1≤i≤M, that is, the i-th terminal device may be any one of the M terminal devices) is not obtained by the first device, an information field corresponding to the i-th terminal device may still be retained, thereby avoiding the destruction of the association relationship between the information fields corresponding to the M terminal devices and the first order.

In some implementations, if the first SLPP message includes positioning-related data of an i-th terminal device among the M terminal devices, an information field corresponding to the i-th terminal device carries first information. The first information includes the positioning related data of the i-th terminal device.

In some implementations, if the first SLPP message does not include positioning-related data of an i-th terminal device among the M terminal devices, an information field corresponding to the i-th terminal device carries second information. The second information is different from the first information. For example, the first information does not include the positioning related data of the i-th terminal device.

In some implementations, values of information elements (IEs) in the second information may each be set to be a default value or marked as absent.

For example, if the first SLPP message is an SLPP ProvideCapabilities message, the ProvideCapabilities-IEs corresponding to the i-th terminal device are set as default values or marked as absent.

For another example, if the first SLPP message is an SLPP ProvideLocationInformation message, the ProvideLocationInformation-IEs corresponding to the i-th terminal device are set to be default values or marked as absent.

For another example, if the first SLPP message is an SLPP ProvideAssistanceData message, the ProvideAssistanceData-IEs corresponding to the i-th terminal device are set to be default values or marked as absent.

In some implementations, the second information may include or only include common information or a common IE for sidelink positioning, and does not include the positioning-related information of the i-th terminal device.

In some implementations, the first information may include the positioning-related data of the i-th terminal device and the common information or common IE for sidelink positioning.

In some implementations, the first information may include only the positioning-related data of the i-th terminal device and not include the common information or common IE for sidelink positioning.

In some implementations, the first information and the second information include the same information IEs, with difference in that values of IEs, other than the common IE, in the second information are each be set to be a default value or marked as absent.

In some implementations, before S410, the method of FIG. 4 may further include that: the first device receives a second SLPP message sent by the second device.

In some implementations, the second SLPP message may be used to indicate that the first device provides the positioning-related data corresponding to the M terminal devices.

For example, the second SLPP message is an SLPP RequestCapabilities message, the first device is a terminal device, and the second device is an LMF. The SLPP RequestCapabilities message may be used to indicate that the first device provides capability information corresponding to the first device by the first device. Further, the SLPP RequestCapabilities message may be used to indicate that the first device provides capability information corresponding to the M terminal devices (i.e., the M terminal devices indicated by the application layer identifiers in the first NAS signaling).

For another example, the second SLPP message is an SLPP RequestLocationInformation message, the first device is a terminal device, and the second device is an LMF. The SLPP RequestLocationInformation message may be used to indicate that the first device provides location information corresponding to the first device. Further, the SLPP RequestLocationInformation message may be used to indicate that the first device provides location information corresponding to the M terminal devices (i.e., the M terminal devices indicated by the application layer identifiers in the first NAS signaling).

For another example, the second SLPP message is an SLPP RequestAssistanceData message, the first device is an LMF and the second device is a terminal device. The SLPP RequestAssistanceData message may be used to indicate that the first device provides positioning assistance data corresponding to the first device. Further, the SLPP RequestLocationInformation message may be used to indicate that the first device provides positioning assistance data corresponding to M terminal devices (i.e., the M terminal devices indicated by the application layer identifiers in the first NAS signaling).

In some implementations, the second SLPP message may not indicate to the first device positioning assistance data of which terminal device(s) among the M terminal devices is required. In this case, the first device may, by default, provide the second device with the positioning-related data of the M terminal devices.

For example, the second SLPP message is an SLPP RequestCapabilities message. The SLPP RequestCapabilities message may be used to indicate that the first device provides capability information corresponding to the first device. Further, the SLPP RequestCapabilities message does not specifically indicate capability information of which terminal device(s) among the M terminal devices (i.e., the M terminal devices indicated by the application layer identifiers in the first NAS signaling) are required. In this case, the first device may, by default, provide the capability information of the M terminal devices.

For another example, the second SLPP message is an SLPP RequestLocationInformation message. The SLPP RequestLocationInformation message may be used to indicate that the first device provides location information corresponding to the first device. Further, the SLPP RequestLocationInformation message does not specifically indicate location information of which terminal device(s) among the M terminal devices (i.e., the M terminal devices indicated by the application layer identifiers in the first NAS signaling) are required. In this case, the first device may, by default, provide the location information of the M terminal devices.

For another example, the second SLPP message is an SLPP RequestAssistanceData message. The SLPP RequestAssistanceData message may be used to indicate that the first device provides positioning assistance data corresponding to the first device. Further, the SLPP RequestAssistanceData message does not specifically indicate positioning assistance data of which terminal device(s) among the M terminal devices (i.e., the M terminal devices indicated by the application layer identifiers in the first NAS signaling) are required. In this case, the first device may, by default, provide the positioning assistance data of the M terminal devices.

In some implementations, the second SLPP message may include first indication information. The first indication information may be used to indicate whether the first device provides the positioning-related data corresponding to the M terminal devices. The first indication information may occupy one or more bits. For example, the first indication information is 1-bit indication information.

Further, in some implementations, the value of the first indication information includes a first value and a second value. The first value may be used to indicate that the first device provides the positioning-related data of the M terminal devices, and the second value may be used to indicate that the first device does not provide the positioning-related data of the M terminal devices.

For example, the second SLPP message is an SLPP RequestCapabilities message. The SLPP RequestCapabilities message includes first indication information (occupying 1 bit). If the value of the first indication information is 1, it indicates that the second device requires the first device to provide capability information of the M terminal devices. If the value of the first indication information is 0, it indicates that the second device only needs the first device to provide its own capability information.

For another example, the second SLPP message is an SLPP RequestLocationInformation message. The SLPP RequestLocationInformation message includes first indication information (occupying 1 bit). If the value of the first indication information is 1, it indicates that the second device requires the first device to provide location information of the M terminal devices. If the value of the first indication information is 0, it indicates that the second device only needs the first device to provide its own location information.

For another example, the second SLPP message is an SLPP RequestAssistanceData message. The SLPP RequestAssistanceDatamessage includes first indication information (occupying 1 bit). If the value of the first indication information is 1, it indicates that the second device requires the first device to provide positioning assistance data of the M terminal devices. If the value of the first indication information is 0, it indicates that the second device only needs the first device to provide its own positioning assistance data.

In some implementations, before sending the first SLPP message to the second device, the first device receives or sends first NAS signaling. For example, if the first NAS signaling is used to carry a sidelink positioning request initiated by a terminal device, the first device is the terminal device, and the second device is LMF, then the first device sends the first NAS signaling to the second device. For another example, if the first NAS signaling is used to carry the sidelink positioning request received by a terminal device, the first device is the terminal device, and the second device is LMF, then the first device receives the first NAS signaling sent by the second device. For another example, if the first NAS signaling is used to carry a response message for the sidelink positioning request received by a terminal device, the first device is the terminal device, and the second device is the LMF, then the first device sends the first NAS signaling to the second device.

It should be understood that the first device or the second device may be a terminal device, and the M terminal devices mentioned above do not include any of the first device and the second device.

### Second Embodiment

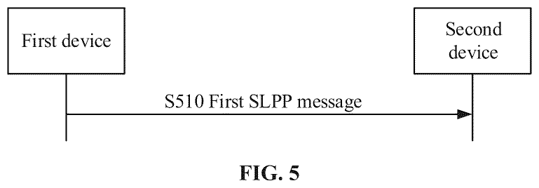

FIG. 5 is a schematic flowchart of a sidelink positioning method provided by a second embodiment of the present application. The method of FIG. 5 may be applied to an in-coverage sidelink positioning procedure. Or, the method of FIG. 5 may be applied to a sidelink positioning procedure involving LMF. The sidelink positioning procedure may be one that is initiated by a terminal device, such as the SL-MO-LR procedure mentioned above. Alternatively, the sidelink positioning procedure may be one that is received by a terminal device, such as the SL-MT-LR procedure mentioned above.

The method of FIG. 5 is described from the perspective of interactions between the first device and the second device. In some implementations, the first device is a terminal device, and the second device is LMF. In some implementations, the first device is LMF, and the second device is a terminal device.

With reference to FIG. 5, in S510, a first device sends a first SLPP message to a second device.

In some implementations, the first SLPP message may be used to provide positioning-related data of a terminal device.

In some implementations, the first SLPP message may be used to provide capability information of a terminal device. For example, the first SLPP message is an SLPP ProvideCapabilities message. In this case, the first device is a terminal device, and the second device is LMF.

In some implementations, the first SLPP message may be used to provide location information of a terminal device. For example, the first SLPP message is an SLPP ProvideLocationInformation message. In this case, the first device is a terminal device, and the second device is LMF.

In some implementations, the first SLPP message may be used to provide positioning assistance data for a terminal device. For example, the first SLPP message is an SLPP ProvideAssistanceData message. In this case, the first device is LMF, and the second device is a terminal device.

In some implementations, the first SLPP message may be used to request capability information of a terminal device. For example, the first SLPP message is an SLPP RequestCapabilities message. In this case, the first device is LMF, and the second device is a terminal device.

In some implementations, the first SLPP message may be used to request location information of a terminal device. For another example, the first SLPP message is an SLPP RequestLocationInformation message. In this case, the first device is LMF, and the second device is a terminal device.

In some implementations, the first SLPP message may be used to request positioning assistance data for a terminal device. For another example, the first SLPP message is an SLPP RequestAssistanceData message. In this case, the first device is a terminal device, and the second device is LMF.

In some implementations, the first SLPP message is associated with a first NAS signaling. For example, the first SLPP message and the first NAS signaling are for the same sidelink positioning procedure. Alternatively, the first SLPP message is triggered (which may be indirectly triggered) by the first NAS signaling.

In some implementations, the first NAS signaling may be used to carry a sidelink positioning request message initiated by a terminal device. The sidelink positioning request message initiated by the terminal device may be an SL-MO-LR request message.

In some implementations, the first NAS signaling may be used to carry a sidelink positioning request message received by a terminal device. The sidelink positioning request message received by the terminal device may be an SL-MT-LR request message.

In some implementations, the first NAS signaling may be used to carry a response message for a sidelink positioning request message received by a terminal device. The response message for the sidelink positioning request message received by a terminal device may be a response message for an SL-MT-LR request message.

In some implementations, the first NAS signaling includes application layer identifiers of M terminal devices for sidelink positioning, and M is a positive integer greater than or equal to 1. The application layer identifiers of the M terminal devices are arranged in the first NAS signaling according to a first order. As an example, assuming that the first NAS signaling includes sequentially an application layer ID of UE a, application layer ID of UE b, and application layer ID of UE c, then the first order is: UE a→UE b→UE c.

In some implementations, the application layer identifiers of the M terminal devices may form an application program ID list, and the application program ID list may record the application layer identifiers of the M terminal devices according to the first order.

As mentioned above, the first NAS signaling may be used to carry an SL-MT-LR request message or a response message for the SL-MT-LR request message. Application layer IDs in the SL-MT-LR request message and the response message for the SL-MT-LR request message may be the same or different. If the application layer IDs in the SL-MT-LR request message and the response message for the SL-MT-LR request message are different, the first NAS signaling may be NAS signaling carrying the SL-MT-LR request message or NAS signaling carrying the response message for the SL-MT-LR request message. Alternatively, whether the first NAS signaling is NAS signaling carrying the SL-MT-LR request message or NAS signaling carrying the response message for the SL-MT-LR request message may be determined based on pre-configuration information, or configuration information from the network device.

In some implementations, the first SLPP message may include indexes of K terminal devices among the M terminal devices. That is, in the second embodiment, the first SLPP message may not directly carry application layer identifiers of terminal devices, but may carry indexes of the terminal devices.

In some implementations, the first SLPP message may further include positioning-related data of the K terminal devices. The indexes of the K terminal devices may respectively be used to indicate a correspondence between the positioning-related data of each of the K terminal devices and the K terminal devices.

In some implementations, the first SLPP message may further include request information for the positioning-related data of the K terminal devices. The indexes of the K terminal devices may respectively be used to indicate a correspondence between the request information for the positioning-related data of each of the K terminal devices and the K terminal devices.

In some implementations, the number of bits occupied by the indexes of terminal devices may be smaller than the number of bits occupied by the application layer identifiers of the terminal devices, and thus signaling overhead is saved.

In some implementations, K is equal to M. That is, the first SLPP message may carry indexes of the M terminal devices.

In some implementations, K is less than M. That is, the first SLPP message may carry indexes of part of the M terminal devices. For example, the first SLPP message is used to provide positioning-related data. If positioning-related data of a certain terminal device among the M terminal devices is not acquired by the first device, the index and the positioning-related data of the terminal device may not be included in the first SLPP message. In this case, K is less than M.

For another example, the first SLPP message may be used to request the provision of positioning-related data. If the first device does not wish to request positioning-related data of a certain terminal device among the M terminal devices, the index of the terminal device and the requested content may not be included in the first SLPP message. In this case, K is less than M.

In some implementations, the indexes of the K terminal devices are determined according to the first order. For example, the indexes of the K terminal devices are numbered according to the first order. As an example, assuming that the first NAS signaling includes sequentially an application layer ID of UE a, application layer ID of UE b, and application layer ID of UE c, that is, the first order is UE a→UE b→UE c, then the index of the UE a may be 1, the index of the UE b may be 2, and the index of the UE c may be 3. If the first SLPP message includes only the indexes of the UE a and UE c, the first SLPP message may include the index 1 and index 3. It is to be noted that the indexes of the K terminal devices are numbered according to the first order, which does not mean that the indexes of the K terminal devices must be numbered from 1. For example, the indexes of the K terminal devices may be numbered from 0 or 2. In addition, the indexes of the K terminal devices being numbered according to the first order does not mean that the indexes of the K terminal devices must be numbered in ascending order, and the indexes of the K terminal devices may be numbered in descending order.

Since the indexes of the terminal devices are determined based on the first order (i.e., the order of the application layer identifiers of the terminal devices in the first NAS signaling), in some embodiments, the indexes of the terminal devices may also be referred to as indexes of the application layer identifiers of the terminal devices.

In the second embodiment, the indexes of the terminal devices, not the application layer identifiers of the terminal devices, are directly carried in the SLPP message. There may be a mapping relationship between the application layer identifiers of the terminal devices and the indexes of the terminal devices, and the mapping relationship may be determined based on the order of the application layer identifiers of the terminal devices in the NAS signaling. Through the above design scheme, positioning-related data of different terminal devices can be distinguished even if the application layer identifiers of the terminal devices are not carried in the SLPP message. Compared with the scheme of the application layer identifiers being directly carried in the SLPP message, carrying the indexes of the terminal devices enables saving of the signaling overhead (since the application layer identifiers are relatively long). Additionally, the indication of the terminal devices in the second embodiment is more flexible than that in the first embodiment. For example, if it is not required to request or provide positioning-related data of a certain terminal device, the SLPP message may not include an information field corresponding to the terminal device.

The implementation of the first SLPP message is described by way of examples in more detail below.

### First Example: The First SLPP Message is an SLPP RequestCapabilities Message

In the first example, the first device may be LMF, and the second device may be a terminal device (hereinafter referred to as UE1). The M terminal devices mentioned above are referred to as UEs 2 to n in the first example.

In the first NAS signaling (which may be used to carry an SL-MO-LR request message, an SL-MT-LR request message, or an SL-MT-LR response message), application layer IDs of the UEs 2 to n constitute an application layer ID list. The SLPP RequestCapabilities message may include a RequestCapabilitiesList, which includes RequestCapabilities-IEs corresponding to each of the UEs 2 to n. The RequestCapabilities-IEs corresponding to the UEs 2 to n respectively include indexes of each of the UEs 2 to n, and the indexes of the UEs 2 to n are numbered according to the order in the application layer ID list. In addition, the RequestCapabilities-IEs of UE1 may be placed first in the RequestCapabilitiesList, and the RequestCapabilities-IEs corresponding to each of the UEs 2 to n may be placed after the RequestCapabilities-IEs of the UE1.

A more specific example of the internal structure of the SLPP RequestCapabilities message is described as follows.
RequestCapabilities::=SEQUENCE {
   criticalExtensions CHOICE {
      c1 CHOICE {
      requestCapabilities RequestCapabilities-IEs,
      requestCapabilitiesList RequestCapabilitiesList,
         spare3 NULL, spare2 NULL, spare1 NULL
      },
      criticalExtensionsFuture SEQUENCE { }
   }
}
RequestCapabilitiesList::=SEQUENCE (SIZE(1 . . . maxUEs)) OF RequestCapabilities-IEs
RequestCapabilities-IEs::=SEQUENCE {
UE-ID-index INTEGER (1 . . . maxUEs) OPTIONAL,
commonIEsRequestCapabilities CommonIEsRequestCapabilities OPTIONAL,
SL-Multi-RTT-ProvideCapabilities SL-Multi-RTT-ProvideCapabilities OPTIONAL,
SL-AoD-RequestCapabilities SL-AoD-RequestCapabilities OPTIONAL,
SL-TDOA-RequestCapabilities SL-TDOA-RequestCapabilities OPTIONAL,
nonCriticalExtensions SEQUENCE { }OPTIONAL,
}

In the above example, the number of elements contained in the RequestCapabilitiesList is denoted by maxUJEs, and maxUEs=n. UE-ID-index is the indexes of the terminal devices mentioned above. The index of each terminal device is located in RequestCapabilities-IEs corresponding to the terminal device in the RequestCapabilitiesList. Additionally, as another implementation, the UE-ID-index may be provided inside specific capability information. For example, the UE-ID-index may be provided inside SL-Multi-RTT-RequestCapabilities, SL-AoD-RequestCapabilities, or SL-TDOA-RequestCapabilities.

### Second Example: The First SLPP Message is SLPP ProvideCapabilities Message

In the second example, the first device may be a terminal device (hereinafter referred as UE1), and the second device may be LMF. The M terminal devices mentioned above are referred to as UEs 2 to n in the second example.

In the first NAS signaling (which may be used to carry an SL-MO-LR request message, an SL-MT-LR request message, or an SL-MT-LR response message), application layer IIDs of the UEs 2 to n constitute an application layer ID list. The SLPP ProvideCapabilities message may include a ProvideCapabilitiesList, which contains ProvideCapabilities-IEs corresponding to each of the UEs 2 to n. The ProvideCapabilities-IEs corresponding to the UEs 2 to n respectively include indexes of each of the UEs 2 to n, and the indexes of the UEs 2 to n are numbered according to the order in the application layer ID list. Additionally, the ProvideCapabilities-IEs of UE1 may be placed first in the ProvideCapabilitiesList, and the ProvideCapabilities-IEs corresponding to each of the UEs 2 to n may be placed after the ProvideCapabilities-IEs of the UE1.

A more specific example of the internal structure of the SLPP ProvideCapabilities message is described as follows.
ProvideCapabilities::=SEQUENCE {
   criticalExtensions CHOICE {
      c1 CHOICE {
         provideCapabilities ProvideCapabilities-IEs,
   provideCapabilitiesList ProvideCapabilitiesList
      spare2 NULL, spare1 NULL
   },
   criticalExtensionsFuture SEQUENCE { }
   }
}
ProvideCapabilitiesList::=SEQUENCE (SIZE(1 . . . maxUEs)) OF ProvideCapabilities-IEs
ProvideCapabilities-IEs::=SEQUENCE {
UE-ID-index INTEGER (1 . . . maxUEs) OPTIONAL,
commonIEsProvideCapabilities CommonIEsProvideCapabilities OPTIONAL,
SL-Multi-RTT-ProvideCapabilities SL-Multi-RTT-ProvideCapabilities OPTIONAL,
SL-AoD-ProvideCapabilities SL-AoD-ProvideCapabilities OPTIONAL,
SL-TDOA-ProvideCapabilities SL-TDOA-ProvideCapabilities OPTIONAL,
nonCriticalExtensions SEQUENCE { }OPTIONAL,
}

In the above example, the number of elements contained in the ProvideCapabilitiesList is denoted by maxUEs, and maxUEs=n. UE-ID-index denotes the indexes of the terminal devices mentioned above. The index of each terminal device is located in ProvideCapabilities-IEs corresponding to the terminal device in the ProvideCapabilitiesList. Additionally, as another implementation, the UE-ID-index may be provided inside specific capability information. For example, the UE-ID-index may be provided inside SL-Multi-RTT-RequestCapabilities, SL-AoD-RequestCapabilities, or SL-TDOA-RequestCapabilities.

### Third Example: The First SLPP Message is an SLPP RequestLocationInformation Message

This implementation is similar to that of the first example, as long as the capability-related information in the first example is replaced with the location-related information.

### Fourth Example: The First SLPP Message is an SLPP ProvideLocationInformation Message

This implementation is similar to that of the second example, as long as the capability-related information in the second example 2 is replaced with the location-related information.

### Fifth Example: The First SLPP Message is an SLPP RequestAssistanceData Message

This implementation is similar to that of the first example, as long as the capability-related information in the first example is replaced with the positioning assistance data-related information. In addition, the transmission direction of the SLPP RequestAssistanceData message is different from that of the SLPP RequestCapabilities message in the first example. In the first example, the LMF sends an SLPP RequestCapabilities message to the UE1, and in the fifth example, the UE1 sends an SLPP RequestAssistanceData message to the LMF.

### Sixth Example: The First SLPP Message is an SLPP ProvideAssistanceData Message

This implementation is similar to that of the first example, as long as the capability-related information in the second example is replaced with the positioning assistance data-related information. In addition, the transmission direction of the SLPP ProvideAssistanceData message is different from that of the SLPP ProvideCapabilities message in the second example. In the second example, the UE1 sends an SLPP ProvideCapabilities message to the LMF, and in the sixth example, the LMF sends an SLPP ProvideAssistanceData message to the UE1. Different terminal devices usually have their own corresponding capability information and location information. Unlike the capability information and location information, different terminal devices may share positioning assistance information. Therefore, the SLPP ProvideCapabilities message may also adopt the implementation of the second SLPP message mentioned later, that is, the SLPP ProvideCapabilities message carries the first indication information mentioned later, detailed description of which may be found in the following. Alternatively, the SLPP ProvideCapabilities message may not indicate a specific terminal device. In this case, it may be considered that the positioning assistance data provided by the SLPP ProvideCapabilities message is common to or shared by the UEs 1 to n.

In some implementations, the first SLPP message is used to provide positioning-related data of K terminal devices. For example, the first SLPP message is the above-mentioned SLPP ProvideCapabilities message, SLPP ProvideLocationInformation message, or SLPP ProvideAssistanceData message. Before S510, the method of FIG. 5 may further include that: the first device receives a second SLPP message sent by the second device. The second SLPP message may be used to request positioning-related data of N terminal devices among the M terminal devices (where N is a positive integer, and K≤N≤M). The second SLPP message may be, for example, the aforementioned SLPP RequestCapabilities message, SLPP RequestLocationInformation message, or SLPP RequestAssistanceData message.

In some implementations, the value of N may be greater than that of K. That is, the number of positioning-related data of the terminal devices provided by the first SLPP message may be smaller than the number of positioning-related data requested by the second SLPP message. For example, the requested positioning-related data of one or some of the N terminal devices may not be obtained by the first device.

In some implementations, the value of N may be equal to that of K. That is, the number of positioning-related data of the terminal devices provided by the first SLPP message may be equal to the number of positioning-related data requested by the second SLPP message.

In some implementations, the first SLPP message may include indexes of the N terminal devices, and the indexes of the N terminal devices are determined based on the first order. For example, the indexes of the N terminal devices are numbered according to the first order. As an example, assuming that the first NAS signaling includes sequentially an application layer ID of UE a, application layer ID of UE b, and application layer ID of UE c, that is, the first order is UE a→UE b→UE c, then the index of the UE a may be 1, the index of the UE b may be 2, and the index of the UE c may be 3. If the second SLPP message includes only the indexes of the UE a and UE c, the second SLPP message may include the index 1 and index 3.

In some implementations, the second SLPP message may include first indication information. The first indication information may be used to indicate whether the first device provides positioning-related data corresponding to the M terminal devices.

In some implementations, the first indication information may include information fields corresponding to the M terminal devices (where the information fields corresponding to the M terminal devices may be located in a list). The first indication information corresponding to the M terminal devices are respectively used to indicate whether the first device provides the positioning-related data of each of the M terminal devices, and an order of the information fields corresponding to the M terminal devices corresponds to the first order.

In some implementations, each of the information fields corresponding to the M terminal devices may occupy 1 bit. Thus, the information fields corresponding to the M terminal devices form a bitmap. The M bits in the bitmap have a one-to-one mapping relationship with the application layer identifiers of the M terminal devices in the first NAS signaling. Thus, the bitmap may also be referred to as a bitmap of indexes of the terminal devices (or UE ID index bitmap). The positioning-related data of multiple terminal devices may be requested through a bitmap. The bitmap occupies a smaller number of bits, and thus signaling overhead can be saved.

As an example, assuming M=3, in the first NAS signaling, three terminal devices are sequentially ordered in the order of UE a, UE b, and UE c. The second SLPP message includes a bitmap containing 3 bits. Among the information fields corresponding to the M terminal devices, the first information field corresponds to the UE a, the second information field corresponds to the UE b, and the third information field corresponds to the UE c. Each of the three information fields occupies 1 bit. Taking the first information field as an example, if the value of one bit in the first information field is 1, it means that the second device indicates that the first device provides positioning-related data of the UE a.

In some implementations, the value of the first indication information includes a first value and a second value. The first value may be used to indicate that the first device provides the positioning-related data of the M terminal devices, and the second value may be used to indicate that the first device does not the positioning-related data of the M terminal devices. For example, the first indication information occupies 1 bit. If the value of the 1 bit is 1, it may indicates that the first device provides the positioning-related data of the M terminal devices. If the value of the 1 bit is 0, it may indicate that the first device does not provide the positioning-related data of the M terminal devices. Compared with the implementation in which the first indication information includes information fields corresponding to the M terminal devices mentioned above, the indication manner provided by the present implementation is simpler, and the signaling overhead is relatively smaller.

Examples of several possible implementations of the second SLPP message are given below.

### First Example: The Second SLPP Message is an SLPP RequestCapabilities Message

In the first example, the first device is LMF, the second device is a terminal device (hereinafter referred to as UE1), and the M terminal devices mentioned above are referred to as UEs 2 to n in the first example.

In the first NAS signaling (which may be used to carry an SL-MO-LR request message, an SL-MT-LR request message, or an SL-MT-LR response message), application layer IDs of the UEs 2 to n constitute an application layer ID list. The RequestCapabilities message may carry first indication information. The first indication information is an n-bit bitmap. This bitmap may be referred to as requestedUE-List. The first bit in the requestedUE-List may correspond to the UE1, and the second to n-th bits in the requestedUE-List may respectively correspond to each of the UEs 2 to n (ordered according to the order in the application layer ID list).

Alternatively, the first indication information may be further simplified. For example, the first indication information may be 1-bit indication information. The first indication information may be used to indicate whether or not the UE1 provides capability information of the UEs 2 to n in the ProvideCapabilities message. That is, the LMF may not specifically request the capability information about which of the UEs 2 to n from the UE1. In this case, the UE1 may understand, based on the first NAS signaling, that the LMF indicates, through the first indication information, the following information that: the capability information of the UEs 2 to n indicated by the application layer identifiers in the first NAS signaling is required or not required by the LMF.

A more specific example of the internal structure of the SLPP RequestCapabilities message is described as follows.
RequestCapabilities::=SEQUENCE {
   criticalExtensions CHOICE {
      c1 CHOICE {
      requestCapabilities RequestCapabilities-IEs,
      spare3 NULL, spare2 NULL, spare1 NULL
   },
   criticalExtensionsFuture SEQUENCE { }
   }
}
RequestCapabilities-IEs::=SEQUENCE {
requestedUE-List BIT STRING (SIZE (maxUEs)) OPTIONAL,
requestedUE2toUEn BOOLEAN OPTIONAL,
nonCriticalExtension SEQUENCE { }OPTIONAL
}

In the above example, BIT STRING represents the bitmap mentioned above, maxUEs=n, that is, the BIT STRING totally includes n bits, the UE1 corresponds to the first bit in the BIT STRING, and the UEs 2 to n respectively correspond to each of the second to n bits in the BIT STRING.

### Second Example: The Second SLPP Message is an SLPP RequestLocationInformation Message

This implementation of the second example is similar to that of the first example, as long as the capability-related information in the first example is replaced with the location-related information.

### Third Example: The Second SLPP Message is an SLPP RequestAssistanceData Message

This implementation of the third example is similar to that of the first example, as long as the capability-related information in the first example is replaced with the positioning assistance-related information. It is also to be noted that the transmission directions of messages are different in the third example and the first example. In the first example, the SLPP RequestCapabilities message is transmitted by the LMF to the UE1, while in the third example, the SLPP RequestAssistanceData message is transmitted by the UE1 to the LMF.

As mentioned above, the first SLPP message includes the indexes of the K terminal devices. In some embodiments, the indexes of the K terminal devices are located in a header of the first SLPP message. In other embodiments, the indexes of the K terminal devices are located in a message body of the first SLPP message.

As mentioned above, the second SLPP message includes the indexes of the N terminal devices. In some embodiments, the indexes of the N terminal devices are located in a header of the second SLPP message. In some embodiments, the indexes of the N terminal devices are located in a message body of the second SLPP message.

In some implementations, the header of the first SLPP message or the second SLPP message (for example, a RequestCapabilities message, a ProvideCapabilities message, a RequestLocationInformation message, a ProvideLocationInformation message, a RequestAssistanceData message, or a ProvideAssistanceData message) may include session IDs. A terminal device may be involved in multiple positioning procedures (where each positioning process may correspond to a session ID), and thus including of the session IDs in the SLPP message helps the terminal device distinguish different positioning procedures.

In some implementations, the header of the first SLPP message or the second SLPP message (for example, a RequestCapabilities message, a ProvideCapabilities message, a RequestLocationInformation message, a ProvideLocationInformation message, a RequestAssistanceData message, or a ProvideAssistanceData message) may include transaction IDs.

In some implementations, the header of the first SLPP message or the second SLPP message (for example, a RequestCapabilities message, a ProvideCapabilities message, a RequestLocationInformation message, a ProvideLocationInformation message, a RequestAssistanceData message, or a ProvideAssistanceData message) may include IDs of terminal devices. The IDs of terminal devices may adopt the indexes of the terminal devices mentioned above, which can reduce the number of bits occupied by the message header, so that the SLPP message is simplified.

In some implementations, before sending the first SLPP message to the second device, the first device receives or sends first NAS signaling. For example, if the first NAS signaling is used to carry a sidelink positioning request initiated by a terminal device, the first device is the terminal device, and the second device is LMF, then the first device sends the first NAS signaling to the second device. For another example, if the first NAS signaling is used to carry a sidelink positioning request received by a terminal device, the first device is the terminal device, and the second device is LMF, then the first device receives the first NAS signaling sent by the second device. For another example, if the first NAS signaling is used to carry a response message for the sidelink positioning request received by a terminal device, the first device is the terminal device, and the second device is the LMF, then the first device sends the first NAS signaling to the second device.

It should be understood that the first device or the second device may be a terminal device, and the M terminal devices mentioned above do not include any of the first device and the second device.

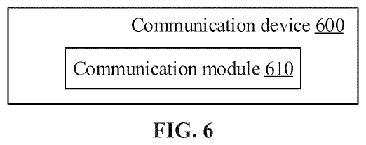

The above has described the method embodiments of the present application in detail with reference to FIGS. 1 to 5, and the following will describe the apparatus embodiments of the present application in detail with reference to FIGS. 6 to 10. It should be understood that the descriptions of the method embodiments and the descriptions of the device embodiments correspond to each other, and thus portions not described in detail may be referred to the foregoing method embodiments.

FIG. 6 is a schematic structural diagram of a communication device provided by an embodiment of the present application. The communication device 600 in FIG. 6 may be the first device in the first embodiment as described above. The network device 600 may include a communication module 610.

The communication module 610 may be configured to send a first SLPP message to a second device, where the first SLPP message is associated with first NAS signaling, the first NAS signaling includes application layer identifiers of M terminal devices for sidelink positioning, the application layer identifiers of the M terminal devices are arranged in the first NAS signaling according to a first order, and M is a positive integer greater than or equal to 1. The first SLPP message includes information fields corresponding to the M terminal devices, the information fields corresponding to the M terminal devices are respectively used to carry positioning related data corresponding to the M terminal devices, and an order of the information fields corresponding to the M terminal devices is determined based on the first order.

In some implementations, if the first SLPP message includes positioning-related data of an i-th terminal device among the M terminal devices, an information field corresponding to the i-th terminal device carries first information; or if the first SLPP message does not include positioning-related data of an i-th terminal device among the M terminal devices, an information field corresponding to the i-th terminal device carries second information. The first information is different from the second information, i is an integer, and 1≤i≤M.

In some implementations, the second information includes common information for sidelink positioning.

In some implementations, the communication module 610 is further configured to: receive a second SLPP message sent by the second device before the first device sends the first SLPP message to the second device. The second SLPP message is used to indicate that the first device provides the positioning-related data corresponding to the M terminal devices.

In some implementations, the second SLPP message includes first indication information, and the first indication information is used to indicate whether the first device provides the positioning-related data corresponding to the M terminal devices.

In some implementations, a value of the first indication information includes a first value and a second value, the first value is used to indicate that the first device provides the positioning-related data of the M terminal devices, and the second value is used to indicate that the first device does not provide the positioning-related data of the M terminal devices.

In some implementations, the first indication information includes one bit.

In some implementations, the first device is a terminal device, and the second device is an LMF.

In some implementations, the first SLPP message is used to provide capability information or location information of a terminal device(s).

In some implementations, the first device is an LMF, and the second device is a terminal device.

In some implementations, the first SLPP message may be used to provide positioning assistance data for a terminal device(s).

In some implementations, the first NAS signaling is used to carry one of the following: a sidelink positioning request message initiated by a terminal device, a sidelink positioning request message received by a terminal device, or a response message for a sidelink positioning request message received by a terminal device.

In some implementations, the communication module 610 is further configured to: receive or send the first NAS signaling before sending the first SLPP message to the second device.

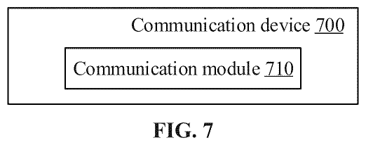

FIG. 7 is a schematic structural diagram of a communication device provided by another embodiment of the present application. The communication device 700 in FIG. 7 may be the second device in the second embodiment as described above. The communication device 700 may include a communication module 710.

The communication module 700 may be configured to receive a first SLPP message sent by a first device, where the first SLPP message is associated with first NAS signaling, the first NAS signaling includes application layer identifiers of M terminal devices for sidelink positioning, the application layer identifiers of the M terminal devices are arranged in the first NAS signaling according to a first order, and M is a positive integer greater than or equal to 1. The first SLPP message includes information fields corresponding to the M terminal devices, the information fields corresponding to the M terminal devices are respectively used to carry positioning related data corresponding to the M terminal devices, and an order of the information fields corresponding to the M terminal devices is determined based on the first order.

In some implementations, if the first SLPP message includes positioning-related data of an i-th terminal device among the M terminal devices, an information field corresponding to the i-th terminal device carries first information; or if the first SLPP message does not include positioning-related data of an i-th terminal device among the M terminal devices, an information field corresponding to the i-th terminal device carries second information. The first information is different from the second information, i is an integer, and 1≤i≤M.

In some implementations, the second information includes common information for sidelink positioning.

In some implementations, the communication module 710 is further configured to: send a second SLPP message to the first device before the second device receives the first SLPP message sent by the first device. The second SLPP message is used to indicate that the first device provides the positioning-related data corresponding to the M terminal devices.

In some implementations, the second SLPP message includes first indication information, and the first indication information is used to indicate whether the first device provides the positioning-related data corresponding to the M terminal devices.

In some implementations, a value of the first indication information includes a first value and a second value, the first value is used to indicate that the first device provides the positioning-related data of the M terminal devices, and the second value is used to indicate that the first device does not provide the positioning-related data of the M terminal devices.

In some implementations, the first indication information includes one bit.

In some implementations, the first device is a terminal device, and the second device is an LMF.

In some implementations, the first SLPP message is used to provide capability information or location information of a terminal device.

In some implementations, the first device is an LMF, and the second device is a terminal device.

In some implementations, the first SLPP message may be used to provide positioning assistance data for a terminal device.

In some implementations, the first NAS signaling is used to carry one of the following: a sidelink positioning request message initiated by a terminal device, a sidelink positioning request message received by a terminal device, or a response message for a sidelink positioning request message received by a terminal device.

In some implementations, the communication module 710 may be further configured to: send or receive the first NAS signaling before receiving the first SLPP message sent by the first device.

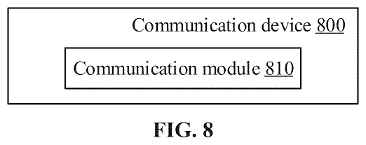

FIG. 8 is a schematic structural diagram of a communication device provided by another embodiment of the present application. The communication device 800 in FIG. 8 may be the first device in the second embodiment as described above. The network device 800 may include a communication module 810.

The communication module 810 may be configured to send a first SLPP message to a second device, where the first SLPP message is associated with first NAS signaling, the first NAS signaling includes application layer identifiers of M terminal devices for sidelink positioning, and the application layer identifiers of the M terminal devices are arranged in the first NAS signaling according to a first order, M being a positive integer greater than or equal to 1. The first SLPP message includes indexes of K terminal devices among the M terminal devices, and the indexes of the K terminal devices are determined based on the first order, where K is a positive integer greater than or equal to 1, and K is less than or equal to M.

In some implementations, the indexes of the K terminal devices being determined based on the first order includes that: the indexes of the K terminal devices are numbered according to the first order.

In some implementations, the first SLPP message is used to provide positioning-related data of the K terminal devices, and the communication module is further configured to: receive a second SLPP message sent by the second device before the first device sends the first SLPP message to the second device. The second SLPP message is used to request positioning-related data of N terminal devices among the M terminal devices. N is a positive integer, and K≤N≤M.

In some implementations, the second SLPP message may include indexes of the N terminal devices, and the indexes of the N terminal devices are determined based on the first order.

In some implementations, the second SLPP message includes first indication information, and the first indication information is used to indicate whether the first device provides the positioning-related data corresponding to the M terminal devices.

In some implementations, the first indication information comprises information fields corresponding to the M terminal devices, the information fields corresponding to the M terminal devices are respectively used to indicate whether the first device provides the positioning-related data of the M terminal devices, and an order of the information fields corresponding to the M terminal devices corresponds to the first order.

In some implementations, each of the M information fields occupies 1 bit.

In some implementations, a value of the first indication information includes a first value and a second value, the first value is used to indicate that the first device provides the positioning-related data of the M terminal devices, and the second value is used to indicate that the first device does not provide the positioning-related data of the M terminal devices.

In some implementations, the first indication information includes one bit.

In some implementations, the first SLPP message includes a header and a message body, and the indexes of the K terminal devices are located in the header or the message body.

In some implementations, the first device is a terminal device, and the second device is an LMF.

In some implementations, the first SLPP message is used to provide capability information of a terminal device, or the first SLPP message is used to provide location information of a terminal device, or the first SLPP message is used to request positioning assistance data for a terminal device.

In some implementations, the first device is an LMF, and the second device is a terminal device.

In some implementations, the first SLPP message is used to provide positioning assistance data of a terminal device, or the first SLPP message is used to request capability information of a terminal device, or the first SLPP message is used to request location information of a terminal device.

In some implementations, the first NAS signaling is used to carry one of the following: a sidelink positioning request message initiated by a terminal device, a sidelink positioning request message received by a terminal device, or a response message for a sidelink positioning request message received by a terminal device.

In some implementations, the communication module 810 may be further configured to: receive or send the first NAS signaling before sending the first SLPP message to the second device.

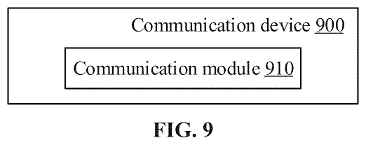

FIG. 9 is a schematic structural diagram of a communication device provided by another embodiment of the present application. The communication device 900 in FIG. 9 may be the second device in the second embodiment as described above. The communication device 900 may include a communication module 910.

The communication module 910 may be configured to receive a first SLPP message sent by a first device, where the first SLPP message is associated with first NAS signaling, the first NAS signaling includes application layer identifiers of M terminal devices for sidelink positioning, and the application layer identifiers of the M terminal devices are arranged in the first NAS signaling according to a first order, M being a positive integer greater than or equal to 1. The first SLPP message includes indexes of K terminal devices among the M terminal devices, and the indexes of the K terminal devices are determined based on the first order, where K is a positive integer greater than or equal to 1, and K is less than or equal to M.

In some implementations, the indexes of the K terminal devices being determined based on the first order includes that: the indexes of the K terminal devices are numbered according to the first order.

In some implementations, the first SLPP message is used to provide positioning-related data of the K terminal devices, and the communication module is further configured to: send a second SLPP message to the second device before the second device receives the first SLPP message sent by the first device. The second SLPP message is used to request positioning-related data of N terminal devices among the M terminal devices. N is a positive integer, and K≤N≤M.

In some implementations, the second SLPP message may include indexes of the N terminal devices, and the indexes of the N terminal devices are determined based on the first order.

In some implementations, the second SLPP message includes first indication information, and the first indication information is used to indicate whether the first device provides the positioning-related data corresponding to the M terminal devices.

In some implementations, the first indication information includes information fields corresponding to the M terminal devices, the information fields corresponding to the M terminal devices are respectively used to indicate whether the first device provides the positioning-related data for the M terminal devices, and an order of the information fields corresponding to the M terminal devices corresponds to the first order.

In some implementations, each of the M information fields occupies 1 bit.

In some implementations, a value of the first indication information includes a first value and a second value, the first value is used to indicate that the first device provides the positioning-related data of the M terminal devices, and the second value is used to indicate that the first device does not provide the positioning-related data of the M terminal devices.

In some implementations, the first indication information includes one bit.

In some implementations, the first SLPP message includes a header and a message body, and the indexes of the K terminal devices are located in the header or the message body.

In some implementations, the first device is a terminal device, and the second device is an LMF.

In some implementations, the first SLPP message is used to provide capability information of a terminal device, or the first SLPP message is used to provide location information of a terminal device, or the first SLPP message is used to request positioning assistance data for a terminal device.

In some implementations, the first device is an LMF, and the second device is a terminal device.

In some implementations, the first SLPP message is used to provide positioning assistance data for a terminal device, or the first SLPP message is used to request capability information of a terminal device, or the first SLPP message is used to request location information of a terminal device.

In some implementations, the first NAS signaling is used to carry one of the following: a sidelink positioning request message initiated by a terminal device, a sidelink positioning request message received by a terminal device, or a response message for a sidelink positioning request message received by a terminal device.

In some implementations, the communication module 910 may be further configured to: send or receive the first NAS signaling before receiving the first SLPP message sent by the first device.

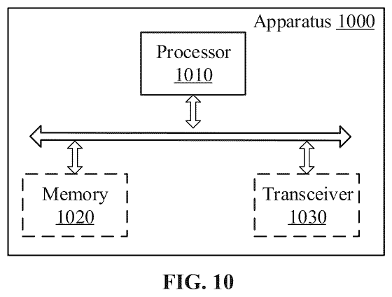

FIG. 10 is a schematic structure diagram of an apparatus provided by an embodiment of the present disclosure. The dashed line in FIG. 10 indicates that the unit(s) or module(s) is optional. The apparatus 1000 may be used to implement the method described in the above method embodiments. The apparatus 1000 may be a chip, a terminal device, or a network device.

The apparatus 1000 may include one or more processors 1010. The processor 1010 may support the apparatus 1000 to implement the method as described in the above method embodiments. The processor 1010 may be a general-purpose processor or a dedicated processor. For example, the processor may be a central processing unit (CPU). Or, the processor may also be another general purpose processor, a digital signal processor (DSP), an application specific integrated circuit (ASIC), a field programmable gate array (FPGA) or other programmable logic devices, discrete gates or transistor logic devices, or discrete hardware components. The general purpose processor may be a microprocessor or any conventional processor.

The apparatus 1000 may include one or more memories 1020. The memory 1020 stores a program, which may be executed by the processor 1010 to cause the processor 1010 to implement the method as described in the above method embodiments. The memory 1020 may be independent of the processor 1010 or may be integrated in the processor 1010.

The apparatus 1000 may include a transceiver 1030. The processor 1010 may communicate with other devices or chips through the transceiver 1030. For example, the processor 1010 may transmit and receive data with other devices or chips through the transceiver 1030.

In an embodiment of the present disclosure, there is further provided a computer-readable storage medium for storing a program. The computer-readable storage medium may be applied to the communication device provided by the embodiments of the present application, and the program causes a computer to execute the method performed by the communication device in various embodiments of the present application.

In an embodiment of the present disclosure, there is further provided a computer program product. The computer program product includes a program. The computer program product may be applied to the communication device provided by the embodiments of the present application, and the program causes a computer to execute the method performed by the communication device in various embodiments of the present application.

In an embodiment of the present disclosure, there is further provided a computer program. The computer program may be applied to the communication devices provided by the embodiments of the present application, and the computer program causes a computer to execute the method performed by the communication device in various embodiments of the present application.

It is to be understood that the terms “system” and “network” herein may be used interchangeably. In addition, the terms used in the present application are for explanation of specific embodiments of the present application only, and are not intended to limit the present application. The terms “first,” “second,” “third,” and “fourth,” etc. in the specification and claims of the present application and the accompanying drawings are used to distinguish different objects, and are not used to describe a specific order. Furthermore, the terms “comprising” and “having” and any variations thereof are intended to cover non-exclusive inclusions.

The “indication” mentioned in the embodiments of the present application may be a direct indication, an indirect indication, or may represent an associated relationship. For example, A indicating B may mean that A directly indicates B, for example, B may be acquired by A. It may also mean that A indicates B indirectly, for example A indicates C, and B may be acquired by C. It may also mean that there is an association relationship between A and B.

In the embodiments of the present application, “B corresponding to A” means that B is associated with A, or B may be determined from A. However, it should also be understood that determining B from A does not mean that B is determined from A alone, and it may also mean that B may also be determined from A and/or other information.

In the embodiments of the present application, the term “correspondence” may indicate that there is a direct correspondence or indirect correspondence between the two, or indicate that there is a correlation relationship between the two, or indicate a relationship between indicating and being indicated, configuring and being configured, or the like.

In the embodiments of the present application, the “predefined” or “pre-configured” may be implemented by pre-storing corresponding codes, tables, or other manners that may be used to indicate relevant information in devices (e.g., including terminal device and network device), the specific implementation of which is not limited by the present application. For example, predefined may refer to what is defined in the protocol.

In the embodiments of the present application, the “protocol” may refer to a standard protocol in communication field, including, for example, an LTE protocol, an NR protocol, and related protocols applied in future communication systems, which are not limited in the present application.

In the embodiments of the present application, the term “and/or” is merely an association relationship for describing related objects, representing that there may be three kinds of relationships. For example, A and/or B may represent the following three situations: i.e., independent existence of A, existence of both A and B, and independent existence of B. In addition, the character “/” in the present disclosure generally represents that an “or” relationship is formed between the previous and next associated objects.

In various embodiments of the present application, the size of the sequence number of the above-described processes does not mean the order of execution, and the order of execution of various processes should be determined by their functions and internal logics, and should not constitute any limitation on the implementation of the embodiments of the present application.

In several embodiments provided herein, it is to be understood that the disclosed systems, apparatuses and methods may be implemented in other manners. For example, the above-described embodiments of the apparatus are only schematic, for example, the division of the units is only a logical function division, and in practice, there may be another division manner, for example, multiple units or components may be combined or integrated into another system, or some features may be ignored or not performed. In addition, the coupling or direct coupling or communication connection between each other illustrated or discussed may be indirect coupling or communication connection through some interfaces, devices or units, and may be electrical, mechanical or other form.

The units illustrated as separate elements may or may not be physically separated, and the elements displayed as units may or may not be physical units, i.e. may be located in a place, or may be distributed over a plurality of network units. Part or all of the units may be selected according to the actual needs to achieve the purpose of the embodiments of the present disclosure.

In addition, various functional unit in various embodiments of the present disclosure may be integrated in one processing unit, each unit may exist physically alone, or two or more units may be integrated in one unit.

The above embodiments may be implemented in whole or in part by software, hardware, firmware, or any combination thereof. When implemented using software, they may be implemented in whole or in part in the form of a computer program product. The computer program product includes one or more computer instructions. When the computer program instructions are loaded and executed on a computer, the processes or functions described in accordance with the embodiments of the present application are generated in whole or in part. The computer may be a general purpose computer, a dedicated computer, a computer network, or other programmable devices. The computer instructions may be stored in a computer-readable storage medium or transmitted from one computer-readable storage medium to another one. For example, the computer instructions may be transmitted from one website, computer, server or data center by wired (e.g. coaxial cable, optical fiber, digital subscriber line (DSL)) or wireless (e.g. infrared, wireless, microwave, etc.) means to another website, computer, server or data center. The computer-readable storage medium may be any available medium that can be read by a computer, or a data storage device including a server, a data center, or the like that encompasses one or more available media integrations. The available media may be magnetic media (e.g., floppy disk, hard disk, magnetic tape), optical media (e.g., digital video disc (DVD)), or semiconductor media (e.g., solid state disk (SSD)), etc.

The above is only the specific implementation of the present disclosure, but the scope of protection of the present disclosure is not limited thereto. Any person skilled in the art may easily think of changes or substitutions within the technical scope disclosed in the present disclosure, which is to be covered within the protection scope of the present disclosure. Therefore, the scope of protection of the present disclosure shall be subject to the scope of protection of the claims.

1. A method of sidelink positioning, comprising:
sending, by a first device, a first sidelink positioning protocol (SLPP) message to a second device,
wherein the first SLPP message is associated with a first non-access stratum (NAS) signaling, the first NAS signaling comprises application layer identifiers of M terminal devices for sidelink positioning, and the application layer identifiers of the M terminal devices are arranged in the first NAS signaling according to a first order, M being a positive integer greater than or equal to 1,
wherein the first SLPP message comprises information fields corresponding to the M terminal devices, the information fields corresponding to the M terminal devices are respectively used to carry positioning-related data corresponding to the M terminal devices, and an order of the information fields corresponding to the M terminal devices is determined based on the first order.

2. The method of claim 1, wherein
if the first SLPP message comprises positioning-related data of an i-th terminal device among the M terminal devices, an information field corresponding to the i-th terminal device carries first information; or
if the first SLPP message does not comprise positioning-related data of an i-th terminal device among the M terminal devices, an information field corresponding to the i-th terminal device carries second information,
wherein the first information is different from the second information, i is a positive integer, and 1≤i≤M,
wherein the second information comprises common information for sidelink positioning.

3. The method of claim 1, further comprising: before sending, by the first device, the first SLPP message to the second device,
receiving, by the first device, a second SLPP message sent by the second device, the second SLPP message being used to indicate that the first device provides the positioning-related data corresponding to the M terminal devices,
wherein the second SLPP message comprises first indication information, and the first indication information is used to indicate whether the first device provides the positioning-related data corresponding to the M terminal devices,
wherein a value of the first indication information comprises a first value and a second value, the first value is used to indicate that the first device provides the positioning-related data of the M terminal devices, and the second value is used to indicate that the first device does not provide the positioning-related data of the M terminal devices, wherein the first indication information comprises 1 bit.

4. The method of claim 1, wherein the first device is a terminal device, and the second device is a location management function (LMF), and
wherein the first SLPP message is used to provide capability information or location information of a terminal device.

5. The method of claim 1, wherein the first device is an LMF, and the second device is a terminal device, and
wherein the first SLPP message is used to provide positioning assistance data of a terminal device.

6. The method of claim 1, wherein the first NAS signaling is used to carry one of:
a sidelink positioning request message initiated by a terminal device,
a sidelink positioning request message received by a terminal device, or
a response message for a sidelink positioning request message received by a terminal device.

7. The method of claim 1, further comprising: before sending, by the first device, the first SLPP message to the second device,
receiving or sending, by the first device, the first NAS signaling.

8. A method of sidelink positioning, comprising:
sending, by a first device, a first sidelink positioning protocol (SLPP) message to a second device,
wherein the first SLPP message is associated with a first non-access stratum (NAS) signaling, the first NAS signaling comprises application layer identifiers of M terminal devices for sidelink positioning, and the application layer identifiers of the M terminal devices are arranged in the first NAS signaling according to a first order, M being a positive integer greater than or equal to 1,
wherein the first SLPP message comprises indexes of K terminal devices among the M terminal devices, and the indexes of the K terminal devices are determined based on the first order, where K is a positive integer greater than or equal to 1, and K is less than or equal to M.

9. The method of claim 8, wherein the indexes of the K terminal devices being determined based on the first order comprises that: the indexes of the K terminal devices are numbered according to the first order,
wherein the first SLPP message is used to provide positioning-related data of the K terminal devices, and the method further comprises: before sending, by the first device, the first SLPP message to the second device,
receiving, by the first device, a second SLPP message sent by the second device, the second SLPP message being used to request positioning-related data of N terminal devices among the M terminal devices, wherein N is a positive integer, and K≤N≤M.

10. The method of claim 9, wherein the second SLPP message comprises indexes of the N terminal devices, and the indexes of the N terminal devices are determined based on the first order; or
wherein the second SLPP message comprises first indication information, and the first indication information is used to indicate whether the first device provides positioning-related data corresponding to the M terminal devices,
wherein the first indication information comprises information fields corresponding to the M terminal devices, the information fields corresponding to the M terminal devices are respectively used to indicate whether the first device provides the positioning-related data of the M terminal devices, and an order of the information fields corresponding to the M terminal devices corresponds to the first order, wherein each of the information field corresponding to the M information fields occupies 1 bit.

11. The method of claim 10, wherein a value of the first indication information comprises a first value and a second value, the first value is used to indicate that the first device provides the positioning-related data of the M terminal devices, and the second value is used to indicate that the first device does not provide the positioning-related data of the M terminal devices, wherein the first indication information comprises 1 bit.

12. The method of claim 8, wherein the first device is a terminal device, and the second device is a location management function (LMF),
wherein the first SLPP message is used to provide capability information of a terminal device, or
the first SLPP message is used to provide location information of a terminal device, or
the first SLPP message is used to request positioning assistance data for a terminal device.

13. The method of claim 8, wherein the first device is an LMF, and the second device is a terminal device,
wherein the first SLPP message is used to provide positioning assistance data for a terminal device, or
the first SLPP message is used to request capability information of a terminal device, or,
the first SLPP message is used to request location information of a terminal device.

14. The method of claim 8, wherein the first NAS signaling is used to carry one of:
a sidelink positioning request message initiated by a terminal device,
a sidelink positioning request message received by a terminal device, or
a response message for a sidelink positioning request message received by a terminal device.

15. The method of claim 8, further comprising: before sending, by the first device, the first SLPP message to the second device,
receiving or sending, by the first device, the first NAS signaling.

16. A first device, comprising: a processor, a memory for storing a program executable by the processor, and a transceiver, wherein the processor is configured to invoke the program from the memory to control the transceiver to receive or send signals, to cause the first device to:
send a first sidelink positioning protocol (SLPP) message to a second device,
wherein the first SLPP message is associated with a first non-access stratum (NAS) signaling, the first NAS signaling comprises application layer identifiers of M terminal devices for sidelink positioning, and the application layer identifiers of the M terminal devices are arranged in the first NAS signaling according to a first order, M being a positive integer greater than or equal to 1,
wherein the first SLPP message comprises information fields corresponding to the M terminal devices, the information fields corresponding to the M terminal devices are respectively used to carry positioning-related data corresponding to the M terminal devices, and an order of the information fields corresponding to the M terminal devices is determined based on the first order.

17. The first device of claim 16, wherein
if the first SLPP message comprises positioning-related data of an i-th terminal device among the M terminal devices, an information field corresponding to the i-th terminal device carries first information; or
if the first SLPP message does not comprise positioning-related data of an i-th terminal device among the M terminal devices, an information field corresponding to the i-th terminal device carries second information,
wherein the first information is different from the second information, i is a positive integer, and 1≤i≤M,
wherein the second information comprises common information for sidelink positioning.

18. The first device of claim 16, wherein the processor is further configured to invoke the program from the memory to control the transceiver to receive or send signals, to cause the first device to: before the first device sends the first SLPP message to the second device,
receive a second SLPP message sent by the second device, the second SLPP message being used to indicate that the first device provides the positioning-related data corresponding to the M terminal devices,
wherein the second SLPP message comprises first indication information, and the first indication information is used to indicate whether the first device provides the positioning related data corresponding to the M terminal devices,
wherein a value of the first indication information includes a first value and a second value, the first value is used to indicate that the first device provides the positioning-related data of the M terminal devices, and the second value is used to indicate that the first device does not provide the positioning-related data of the M terminal devices, wherein the first indication information comprises 1 bit.

19. The first device of claim 16, wherein the first device is a terminal device, and the second device is a location management function (LMF), and
wherein the first SLPP message is used to provide capability information or location information of a terminal device.

20. The first device of claim 16, wherein the first device is an LMF, and the second device is a terminal device, and
wherein the first SLPP message is used to provide positioning assistance data for a terminal device.
